(19) United States
(12) Patent Application Publication
(10) Pub. No.: US 2024/0183989 A1
(43) Pub. Date: Jun. 6, 2024

(54) WEED DETECTOR AND METHOD OF WEED DETECTION

(71) Applicant: STEALTH TECHNOLOGIES PTY LTD, Subiaco (AU)

(72) Inventor: Elliot Nicholls, Subiaco (AU)

(73) Assignee: STEALTH TECHNOLOGIES PTY LTD, Subiaco, WA (AU)

(21) Appl. No.: 18/549,727

(22) PCT Filed: Mar. 9, 2022
(86) PCT No.: PCT/AU2022/050195

§ 371 Date: Sep. 8, 2023

(30) Foreign Application Priority Data
Mar. 9, 2021 (AU) 2021900668
Aug. 12, 2021 (AU) 2021902507
Aug. 25, 2021 (AU) 2021107451

(51) Int. Cl. G01S 17/89; G01B 11/06; G06T 7/11

(52) U.S. Cl. CPC G01S 17/89; G01B 11/0608; G06T 7/11; G06T 2207/10028; G06T 2207/30188; G06T 2207/30252

(57) ABSTRACT

A method and system of weed detection comprises scanning a laser across a crop from a moving vehicle at a height above the top of the crop and at an acute angle to horizontal: detecting return reflections of the laser from the scanned crop; creating a data point cloud from the reflections; and processing the point cloud to estimate locations of weeds that have grown to a height above a designated height of the crop.

### FIELD OF THE INVENTION

The present invention relates to detection of weeds in a crop.

### BACKGROUND

The following discussion of the background art is intended to facilitate an understanding of the present invention only. It should be appreciated that the discussion is not an acknowledgement or admission that any of the material referred to was part of the common general knowledge as at the priority date(s) of the application.

A problem with crop farming, particularly those such as wheat, barley, corn, etc., is that weeds will grow up together with the crops and present a present and future problem to the farmer. These weeds are becoming herbicide resistant, and therefore cannot easily be treated with mass herbicide application.

There is technology to deal with weeds that occur beneath the crop canopy at harvest time, and have not yet seeded, that can destroy weed seeds in the combine harvester. However, for weeds that have already seeded and for weeds that protrude up through the crop canopy there is no known solution.

These weeds present a problem. Weeds that go to seed in the crop field will deposit many seeds into the ground. These seeds can remain dormant for many years (up to 50 years in some cases). Thus, knowing the location of weeds and weed clusters is a critical first step to managing weeds that are becoming increasingly resistant to herbicides.

The present invention has been developed in light of this background to assist in detecting and locating weeds in a crop field so that the farmer can manage these weeds knowing the location in the crop field through various agronomic techniques.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF THE INVENTION

According to a first aspect there is provided a method of weed detection comprising:
scanning a laser across a crop from a moving vehicle at a height above the top of the crop and at an acute angle to horizontal;
detecting return reflections of the laser from the scanned crop;
creating a data point cloud from the reflections;
processing the point cloud to estimate locations of weeds that have grown to a height above a designated height of the crop.

In an embodiment the designated height of the crop is determined by identifying a surface of the top of the crop from points in the point cloud. The surface may be over the top of the crop but may be generally through the top as determined on a statistical or other appropriate basis. Typically, an averaging or statistical or other technique is used to define the surface as a 2 dimensional surface that extends in 3 dimensional space, that need not be planar. In an embodiment processing the point cloud to estimate locations of weeds comprises processing the point cloud to identify the location of data points representing outliers above the surface, which are designated as representing weeds.

In an embodiment the identifying the surface of the top of the crop from points in the point cloud comprises processing the point cloud to recognise peaks of broadacre crop plants wherein the recognised peaks define points or are used to define points in the surface. In an embodiment the surface is segmented into substantially horizonal surface planar regions that extend across or substantially across corresponding regions of the tops of the plants of the crop. In an embodiment the surface is segmented into continuous surface regions of differing orientation that extend across or substantially across the tops of the plants of the crop. In an embodiment the surface is segmented into triangles that extend across or substantially across the tops of the plants of the crop. In an embodiment the surface is determined without identifying individual plants in the crop.

In an embodiment the method further comprises processing the outliers to find probable clusters of weeds from outliers that are proximal to each other and are significantly above the surface, preferably above the surface regions. In an embodiment, clusters of weeds are determined without identification of individual weeds.

In an embodiment the locations of the weeds are determined relative to the vehicle. In an embodiment the method further comprises obtaining the location of the vehicle and mapping the location of the vehicle to the locations of weeds. In an embodiment the location of the vehicle and the location of weeds relative to the vehicle are used to determine global positions of the weeds so that the weed's (or the clusters' of weeds) locations can be ascertained on a later occasion.

In an embodiment the processing comprises cropping and orienting points in the data cloud.

In an embodiment the processing comprises filtering. In an embodiment the processing comprises dividing the data points into regions.

In an embodiment each region is defined by a substantially horizontal plane. In an embodiment the defining of each horizontal plane is by RANSAC plane segmentation.

In an embodiment outlier points above the region are identified. In an embodiment proximal outlier points are grouped and designated as a cluster of weeds.

In an embodiment grouping of proximal outlier points is by determining nearest neighbour points. In an embodiment determining nearest neighbour points is determined by a k-d tree radius search. In an embodiment groups of one or more outliers are designated as a cluster of weeds. In the case of a group containing more than one outlier, the radius of the cluster of weeds is calculated as half the distance between the minimum and maximum outlier positions. In the case of a group containing a single outlier, the radius of the cluster of weeds is the typical minimum radius of a head of a weed. Typically, the radius will be large enough to eliminate most false positives.

According to a second aspect there is provided a method of detecting weeds, comprising:
receiving a data point cloud from a LIDAR scan of a top of the crop from a moving vehicle;
processing the point cloud to estimate locations of weeds that are determined to be above a determined height above a determined top surface of the crop.

In an embodiment the processing is according to one or more of the above steps in paragraphs [0010] to [0018].

According to a third aspect there is provided a weed detector comprising:
a laser arranged for scanning across a crop from a moving vehicle at a height above the top of the height of the crop and at an acute angle to horizontal;
a laser detection sensor for detecting return reflections of the laser from the scanned crop;
a processor for creating 3D data point cloud from the reflections;
a processor for processing the point cloud to estimate locations of weeds that are determined to be above a determined height above a determined top surface of the crop.

In an embodiment the detector comprises a location detector for detecting the location of the vehicle as this performs the laser scanning.

In an embodiment the detector comprises an adjustor of the angle of the laser.

According to a fourth aspect there is provided a computer program for detecting weeds embodied in a non-volatile form, comprising instructions which when executed by a processor configure the processor to:
receive a data point cloud from a LIDAR scan of a top of the crop from a moving vehicle;
process the point cloud to estimate locations of weeds that are determined to be higher than a determined top surface of the crop.

In an embodiment the processor is configured to perform the processing steps above in any one or more of paragraphs [009] to [0020].

In an embodiment the determined top surface of the crop is the mean height of plants in the crop within a designated area of the top surface of the crop.

### BRIEF DESCRIPTION OF DRAWINGS

In order to provide a better understanding, embodiments will be descried in relation to the accompanying drawings, in which:

FIG. 1 is a schematic elevation of a weed detector according to an embodiment of the present invention;

FIG. 2 is a schematic elevation showing operation of the weed detector of FIG. 1 on a crop;

FIG. 3 is a schematic representation of a laser patten directed at the crop of FIG. 2;

FIG. 4 is a block diagram of a weed detector according to an embodiment of the present invention;

FIG. 5 is a block diagram of processor elements of weed detector according to an embodiment of the present invention; and

FIG. 6 is a flow chart showing a method of detecting weeds according to an embodiment of the present invention.

### DESCRIPTION OF EMBODIMENTS

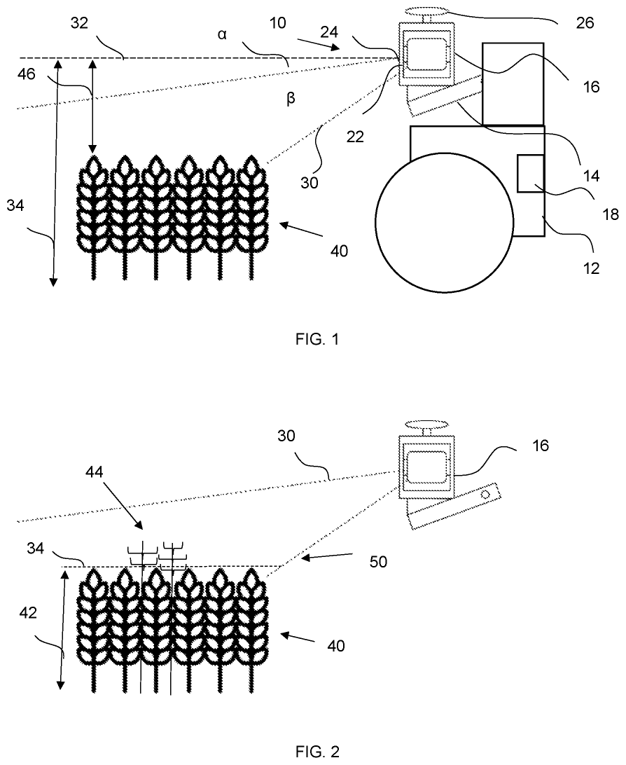

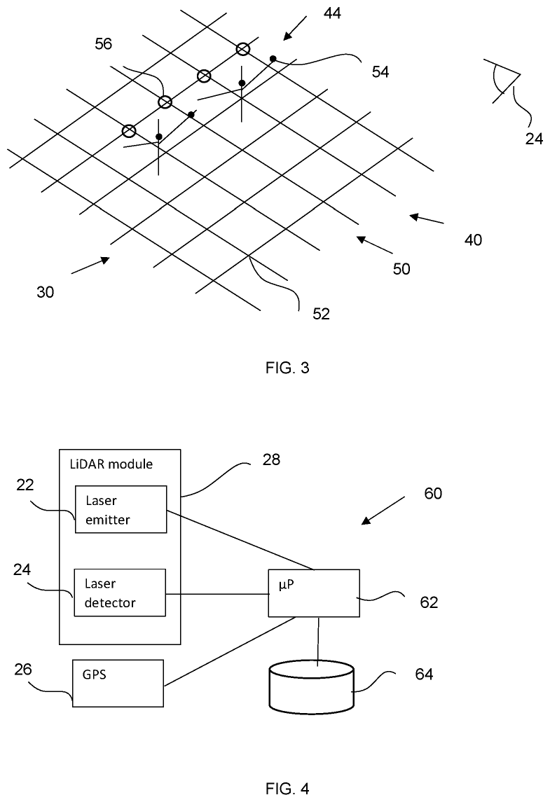

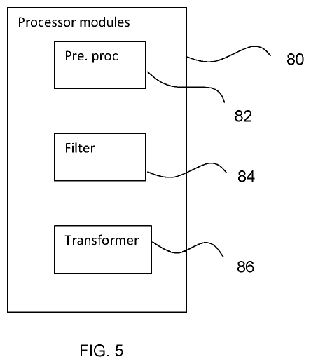

Referring to FIGS. 1 and 2, a weed detector 10 is operated from a moving vehicle 12, such as a harvester or other farm equipment. Alternatively, the vehicle could be an aircraft, such as an aeroplane, helicopter or drone. A body 16 of the detector is fixed by a mount 14 to the vehicle 12 at a height 34 represented by the horizontal plane 32 from the ground. Height 34 is higher than a height 42 of a canopy of a crop 40 represented by horizontal plane 36. Height 34 will also preferably be above the height of weeds 44 that grow above the height 42 of the crop 40. The weed detector 10 is above the top of the crop 40 by distance 46. Of course, the top of the crop 40 will not be perfectly uniform, so height 34 should accommodate variation in distance 46. Height 34 may vary according to the variety of crop 40. For example, in the case of the harvester, height 34 may be 2 m, 2,2 m, 2.4 m, 2.5 m, 2.6 m, 2.8 m, 3 m, 3.2 m, 3.4 m, 3.5 m, 3.6 m, 3.8 m, 4 m, or some other suitable amount. Preferably the body 16 is mounted to be 0.2 m, 0.3 m, 0.4 m, 0.5 m, 0.6 m, 0.7 m, 0.8 m, 0.9 m, 1 m, 1.1 m, 1.2, 1.3 m, 1.4 m, 1.5 m, 1.6 m, 1.7 m, 1.8 m, 1.9 m, 2 m or some other suitable distance 46 from the expected height 42 of the crop 40 of a certain type. More preferably, between 0.5 m and 1 m from the average height 42 of the top of the crop 40.

The body 16 houses an emitter 22, a sensor 24 and preferably a location receiver 26. The emitter 22 emits a laser beam 30 which scans the top of the crop 40, typically through a range of angles (spreading across angle β) which begin at an acute angle α down from the horizontal plane 32. The sensor 24 detects reflections of the laser on the crop 40 and on the weeds 44, as described further below. The location receiver 26 is preferably a receiver of Global Position Satellite (GPS) signals that enable the location receiver 26 to determine its location, such as in precise latitude and longitude values, substantially in real time as the vehicle 12 moves and the laser scans the crop 40. The vehicle 12 preferably has an odometer 18 to measure distance travelled, although this could be determined by a difference in GPS coordinates at different points in time.

In an embodiment, the mount 14 comprises an adjustor that permits adjustment of the pitch angle of the body 16, so that the angle α of the emitted beam 30 is as desired, and well as the yaw angle to ensure the body 16 and thus the beam is directed straight, or as otherwise required. Preferably angle α of the emitted beam 30 is relatively shallow, such as between 5° and 30°, more preferably between 10° and 20° and more preferably still at 15°. Preferably the angle β is about 10° to 45°, more preferably between 20° and 40° and more preferably still at 30°. Alternatively, each scan could be a single line.

In an embodiment the laser emits a beam of coherent infrared light, where the beam is scanned across the top of the crop 40 in one or more lines and dwells at points to illuminate the point with the laser for a period of time before moving on to the next point. Typically, the laser operates using a Light Detection and Ranging (LiDAR) technique. Referring to FIG. 3, the points are represented by intersections 52 of the grid 50 of lines. The laser will typically be scanned in parallel lines. It may scan in a grid, but the grid is used in the figure for illustrative purposes. That is to say there need not be two sets of parallel lines that for example form the illustrated grid.

In an embodiment the entire crop may be scanned so as to create a data point cloud of the entire crop. Alternatively, parts may be scanned and processed at a time, or the LIDAR scan may be processed frame by frame. Processing more, preferably the entire, of the crop has the advantage of the statistical technique to clean and process the data can become more effective or more accurate.

When the canopy of the crop is substantially even the points will substantially form points in a plane. In reality the 2 dimensional surface represented by the points 52 will undulate in 3 dimensional space with the actual height of the tops of each plant's canopy due to different heights of each plant and due to undulation in the ground in which the plants are growing. The undulation can be accommodated by allowing the surface to be segmented into regions, such as for example, by segmenting into different regions of different height horizontal planes or different regions of planes at different angles to horizontal, such as by a triangle mesh. Alternatively, the surface may be a substantially smooth 2D surface. For simplicity, the surface is illustrated as a horizontal plane defined by the grid 50, but it is to be understood that it need not be.

Weeds 44 that protrude above the surface will be struck by the laser and will be illuminated, as represented by dots 54. The weeds 44 will block the laser beam 30, which will cast a shadow, represented by hollow circles 56. When the sensor 24 sees the points 52 and 54 it is able to determine the range of the illuminated points by techniques known to those skilled in LiDAR. The sensed illuminated points 52, 54 thus can be used to form a 3-dimensional point cloud. If the sensor 24 is higher than the emitter 22, then it may also detect the shadow points 56. Typically, shadows are not relied upon.

In an embodiment the sensor 24 is detector in the form of a camera suitable for detecting the illumination of the points. The emitter 22 and sensor 24 may be in the form of a commercially available LiDAR module 28.

An example LiDAR module is a MRS6000 LIDAR (SICK AG, Australia). It has 24 scanning layers of vertical pixels across the scans, for gap-free and reliable detection, and a scanning frequency of 10 Hz. The LiDAR had an angular resolution of 0.13°, with a maximum horizontal and vertical aperture of 120° and 15°, respectively. The working range of the LiDAR is from 0.50 m to 200 m with the ambient operating temperature of −20° C. to +60° C. The source of light was an infrared laser of 905 nm, with distances calculated based on the return times of the beams. Other suitable LiDAR modules may be used.

Referring to FIG. 4, the weed detector 10 comprises components 60, which include the emitter 22, sensor 24 and location receiver 26 electronically connected to a processor 62 preferably having a storage device 64. In an embodiment the GPS receiver is a high-precision GPS (with GNSS RTK). For example, the GPS may be a Piksi Multi Real-Time Kinematic GPS receiver and base station, with centimetre accuracy. Other suitable GPS receivers may be used.

The processor 62 is configured to control the emitter 22 and receive data representing the 3-D point data cloud from the sensor 24, and other data (preferably including the GPS and odometer reading or other inertial movement unit), store the data cloud in the storage 64 and process the data. In an embodiment the processing of the data cloud can occur at a later time, but can be performed in real time. In an embodiment the processing of the data cloud has a number of stages. Accordingly, the processor 62 may be configured to act as number of processor modules 80. In an embodiment the processor modules comprise one or more of: a pre-processor 82, a filter 84 and a transformer 86.

The processor 62 may be an electronic circuit configured to perform one or more parts of the processing described herein. It may be a programmable controller, or a microprocessor controlled by one or more computer programmes, stored in storage 64 or otherwise in a non-volatile form, comprising instructions which when executed cause the microprocessor to perform one or more parts of the processing described herein. The processor 62 may be for example an ADLINK embedded computer.

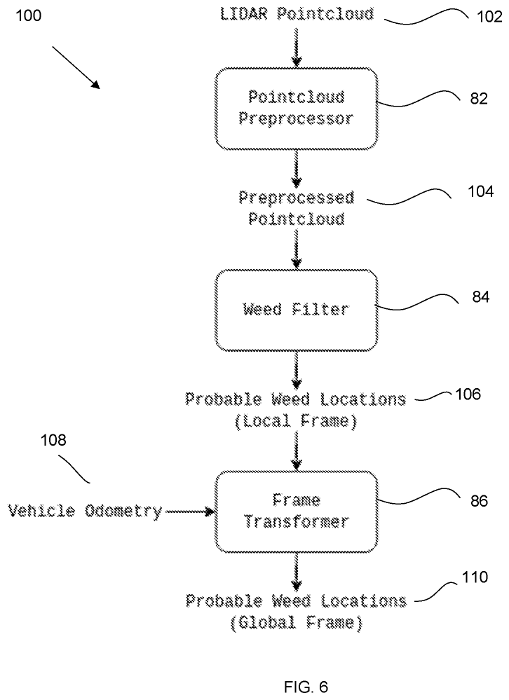

Referring to FIG. 6, a method 100 of processing the data cloud 102 is shown. The data cloud is pre-processed with pre-processor module 82 in order to crop and orient points in the data cloud 102.

The pre-processed point cloud 104 identifies one or more regions of a surface that extends over or through the tops of the canopies of the crop. In an example the identification of the surface is conducted by filtering the point cloud 104 with filter module 84 to have the surface be subdivided into regions on the X-Y (substantially horizontal) plane 34. For each sub-region, Random Sample Consensus (RANSAC) plane segmentation is used to estimate the equation of the crop plane 34 region. The estimated crop plane 34 region defines a designated height of the crop in that region of the crop. While possible, it is unnecessary to identify individual plants in the crop. From the defined surface, or from each region of the surface, points above a designated height above the surface/region can be identified as probably weeds.

Accordingly, all outlier points found at a specified height above the crop plane 34 region (designated height of the crop) are designated as belonging to probable weeds in created probable weed location data 106. For example, the specified height could be 2, 3 or 4 times the standard deviation of crop height above the mean crop height, with a minimum threshold of 0.15 m.

These outliers in the probable weed location data 106 are grouped by transformer 86 by proximity using a nearest neighbour search, such as a k-d tree radius search, forming probable weed clusters.

In the case of a group containing more than one outlier, the radius of the cluster of weeds is calculated as half the distance between the minimum and maximum outlier positions. In the case of a group containing a single outlier, the radius of the cluster of weeds is the typical minimum radius of a head of a weed. Typically, the radius will be large enough to eliminate most false positives. Accordingly, individual weeds need not be detected.

The local coordinate frame is then transformed relative to the vehicle's global position and heading with GPS data and preferably odometer data 108, producing the geographic coordinates of the weed clusters in probable weed group locations data 110. The weed cluster may be defined as an area of defined shape (including a circle or triangle or a polygon) of a defined size, having one or more identifying positions (such as centre, or a vertex).

Accordingly, the detector and subsequently processed data detects probable weeds from the vehicle-mounted LIDAR point cloud and infers their geographic coordinates. The output of the system is the GPS coordinate of the (probable) detected weeds or weed clusters. The GPS coordinates may be processed through a Kalman Filter which fuses a point cloud by predicting the sensor state vector (position orientation and speed) to produce a global from of the LIDAR point cloud. This information can be used to inform weed management practices, such as for example targeted herbicide spraying, or extra crop seeding.

Weeds for which the present invention may be suitable include, but are not limited to: cannabis (Cannabis sativa) and brown mustard (Brassica juncea (L.) Czern) weeds in spring wheat in western Canada, annual sow thistle (Sonchus oleraceus L.) in wheat crops in eastern Australia, and wild oat (Avena fatua L.), wild radish (Raphanus raphanistrum L.) and sow thistle in wheat, barley (Hordeum vulgare L.), lupin (Lupinus angustifolius L.) and chickpea (Cicer arietinum L.) crops in the central Wheat-belt region of Western Australia.

In a trial with a LIDAR scan distance of 30 m seeking 64 known weeds in an area of 2613 m², crop height in the study area ranged between 0.60 and 0.80 m, with an average height of 0.70 m (SD±0.33). The study area had a grid of 418 cells, each of 2.5×2.5 m. The number of cells that were classified correctly (either True Positives or True Negatives) at height threshold of >mean+2SD and minimum detection per cell of >0, >SD and >2SD were 122, 222 and 271 with the classification accuracy of 29, 53 and 65%, respectively. The classification accuracy increased at a height threshold of >mean+3SD and minimum detection per cell of >0, >SD and >2SD, to 203, 278 and 307 with the classification accuracy of 49, 67 and 73%, respectively. There was a further increase in classification accuracy at the height threshold of >mean+4SD and minimum detection per cell of >0, >SD and >2SD, to 297, 320 and 321 with the classification accuracy of 71, 76 and 77%, respectively. Overall, the number of true positives and false positives declined with increasing height threshold and increasing minimum number of detections required, from >0 to >2SD. By contrast, the number of true negatives and false negatives increased with increasing height threshold and minimum number of detections required.

Considering the known 64 weeds, rather than the cells, the percentage of detected weeds at a height threshold of >mean+2SD and minimum detection per cell of >0, >SD and >2SD were 97, 75, and 51, respectively. The percentage of known weeds detected decreased with increasing height threshold and increasing minimum number of detections per cell, to the height threshold of >mean+4SD and minimum detection per cell of >0, >SD and >2SD, which ranged between 62, 39, and 36, respectively.

The trial results demonstrated, at best, 97% of the weeds present in the study area were detected, leaving 3% undetected. This was at the lowest threshold set at mean crop height +2SD and with at least one LiDAR ‘detection’ per cell required.

The data for an entire field from the sensors including LiDAR, GPS and IMU can be collected and stored for later processing or transmitted for external processing. The collected LIDAR data can be assembled into a contiguous point cloud representing the entire field, with various corrections applied using data from, for example, the IMU and GPS to account for the motion of the sensors through the field, and for the lowering and/or raising of the sensors with respect to the ground and crop canopy. The assembled point cloud data of the entire field can be used to perform the analysis on the locations of the weeds (as described above) using statistical and other algorithms over the entire field data set thereby providing a whole picture of the field as well as allowing the algorithms to work with a larger data set, allowing for improved the accuracy of the analysis.

The resulting locations of weed clusters may be displayed on a map to understand weed infiltration and devise weed management strategies. The present invention may be employed with other weed detection technologies to enhance or improve the resulting location of weed cluster data.

Modifications may be made to the present invention within the context of that described and shown in the drawings. Such modifications are intended to form part of the invention described in this specification.

1. A method of weed detection comprising:
scanning a laser across a crop from a moving vehicle at a height above the top of the crop and at an acute angle to horizontal;
detecting return reflections of the laser from the scanned crop;
creating a data point cloud from the reflections; and
processing the point cloud to estimate locations of weeds that have grown to a height above a designated height of the crop.

2. The method according to claim 1, wherein the designated height of the crop is determined by identifying a surface of the top of the crop from points in the point cloud.

3. The method according to claim 1, wherein an averaging or statistical or other technique is used to define the surface as a 2 dimensional surface that extends in 3 dimensional space.

4. The method according to claim 1, wherein processing the point cloud to estimate locations of weeds comprises processing the point cloud to identify the location of data points representing outliers above the surface, which are designated as representing weeds.

5. The method according to claim 4, wherein the identifying the surface of the top of the crop from points in the point cloud comprises processing the point cloud to recognise peaks of broadacre crop plants wherein the recognised peaks define points or are used to define points in the surface.

6. The method according to claim 5, wherein each region is defined by a substantially horizontal plane defined by RANSAC plane segmentation.

7. The method according to claim 5, wherein the surface is segmented into substantially horizonal surface planar regions that extend across or substantially across corresponding regions of the tops of the plants of the crop.

8. The method according to claim 7, wherein outlier points above the region are identified by determining nearest neighbour points.

9. The method according to claim 8, wherein determining nearest neighbour points is determined by a k-d tree radius search.

10. The method according to claim 9, wherein groups of one or more outliers are designated as a cluster of weeds, wherein in the case of a group containing more than one outlier, the radius of the cluster of weeds is calculated as half the distance between the minimum and maximum outlier positions.

11. The method according to claim 10, wherein the radius is large enough to eliminate most false positives.

12. The method according to claim 1, wherein the surface is segmented into continuous surface regions of differing orientation that extend across or substantially across the tops of the plants of the crop.

13. The method according to claim 1, wherein the locations of the weeds are determined relative to the vehicle.

14. The method according to claim 13, wherein the method further comprises obtaining the location of the vehicle and mapping the location of the vehicle to the locations of weeds.

15. A method of detecting weeds, comprising
receiving a data point cloud from a LiDAR scan of a top of the crop from a moving vehicle;
processing the point cloud to estimate locations of weeds that are determined to be above a determined top surface of the crop.

16. A weed detector comprising:
a laser arranged for scanning across a crop from a moving vehicle at a height above the top of the height of the crop and at an acute angle to horizontal;
a laser detection sensor for detecting return reflections of the laser from the scanned crop;
a processor for creating 3D data point cloud from the reflections; and
a processor for processing the point cloud to estimate locations of weeds that are determined to be above a determined height above a determined top surface of the crop;
a processor for processing the point cloud to estimate locations of weeds the crop.

17. The weed detector according to claim 16, wherein the detector comprises an adjustor of the angle of the laser.

18. (canceled)
